(19) United States
(12) Patent Application Publication
(10) Pub. No.: US 2024/0286744 A1
(43) Pub. Date: Aug. 29, 2024

(54) DEVICE FOR DRAINING A WASTE WATER TANK COMPRISING A HATCH INCORPORATING A LIQUID STORE, AIRCRAFT HAVING AT LEAST ONE SUCH DRAINAGE DEVICE

(71) Applicant: Airbus Canada Limited Partnership, MIRABEL (CA)

(72) Inventors: Marion GOURGUES, MIRABEL (CA); Marc-André ROY, MIRABEL (CA); Christophe RODRIGUEZ, MIRABEL (CA)

(21) Appl. No.: 18/438,918

(22) Filed: Feb. 12, 2024

(30) Foreign Application Priority Data
Feb. 28, 2023 (FR) 2301809

(51) Int. Cl. B64D 11/02; F16K 1/20

(52) U.S. Cl. CPC B64D 11/02; F16K 1/2007

(57) ABSTRACT

A drainage device for a tank of an aircraft, comprising a drainage duct, a drainage valve positioned between the upstream and downstream ends of the drainage duct, a housing dimensioned to house at least the downstream end of the drainage duct and a hatch moveable between an open position and a closed position in which the hatch closes the housing. The hatch comprises a liquid store positioned on the inner face thereof, into which the drainage duct opens when the hatch is in the closed position. The liquid store collects and stores liquid coming out of the drainage duct in the event of leakage from the drainage valve. Also an aircraft with such a drainage device.

### CROSS-REFERENCES TO RELATED APPLICATIONS

This application claims the benefit of French Patent Application Number 2301809 filed on Feb. 28, 2023, the entire disclosure of which is incorporated herein by way of reference.

### FIELD OF THE INVENTION

The present application relates to a device for draining a waste water tank comprising a hatch incorporating a liquid store and to an aircraft having at least one such drainage device.

### BACKGROUND OF THE INVENTION

According to one embodiment, an aircraft comprises at least one tank intended to store waste water, an evacuation system intended to generate a reduced pressure in the tank, and a drainage device configured to drain the tank. This drainage device comprises a drainage duct that has an upstream end opening into the tank and a downstream end, opening outside the fuselage of the aircraft, to which a discharge duct may be connected and a drainage valve positioned between the upstream and downstream ends of the drainage duct and configured to occupy a permissive state in which the drainage valve allows a flow in the drainage duct, from the upstream end towards the downstream end, and a closed state in which the drainage valve prevents any flow in the drainage duct.

Additionally, the drainage device comprises a housing that is recessed with respect to the outer surface of the fuselage of the aircraft, and a hatch moveable between an open position in which the hatch opens the housing and a closed position in which the hatch closes the housing and has an outer face extending from the outer surface of the fuselage. This housing is dimensioned to house at least the downstream end of the drainage duct as well as a control configured to control the state of the drainage valve.

Over time, wear of the drainage valve can give rise to a slight leakage of the waste water. In order to prevent any flow outside the fuselage outside of the drainage periods, the drainage device comprises a cap configured to cooperate with the downstream end of the drainage duct and occupy a closed position in which the cap closes off the downstream end of the drainage duct and an open position in which the cap frees the downstream end of the drainage duct.

In some cases, the volume of the housing beneath the hatch is not enough to house the drainage duct fitted with its cap, and therefore the geometry of the hatch has to be modified so that the cap does not interfere with the hatch in the closed position. This modification usually results in a bump on the outer surface of the fuselage, which causes aerodynamic disturbances.

### SUMMARY OF THE INVENTION

The present invention is intended to overcome some or all of the drawbacks in the prior art.

To this end, the invention relates to a drainage device for a tank of an aircraft, comprising a drainage duct that has an upstream end designed to open into the tank and a downstream end to which a discharge duct may be connected, a drainage valve positioned between the upstream and downstream ends of the drainage duct, a housing dimensioned to house at least the downstream end of the drainage duct and a hatch moveable between an open position in which the hatch opens the housing and a closed position in which the hatch closes the housing, the hatch comprising an inner face oriented toward the drainage duct when the hatch is in the closed position.

According to the invention, the hatch comprises a liquid store positioned on the inner face thereof, into which the drainage duct opens when the hatch is in the closed position, designed to collect and store any liquid coming out of the drainage duct.

This liquid store rigidly connected to the hatch obviates the need to provide a separate cap for the hatch to prevent the liquid coming from a potential leak in the drainage valve from escaping outside the aircraft.

According to another feature, the liquid store comprises at least one lateral wall that extends along a closed perimeter between a lower edge joined to the inner face of the hatch and an upper edge remote from the inner face of the hatch.

According to another feature, the lateral wall has a height, corresponding to a distance between the lower and upper edges thereof, such that the downstream end of the drainage duct is positioned between the inner face of the hatch and a surface containing the upper edge of the lateral wall.

According to another feature, the upper edge of the lateral wall is positioned in a substantially horizontal plane when the hatch is in the closed position.

According to a first embodiment, the closed perimeter followed by the lateral wall is remote and separate from the drainage duct.

According to a second embodiment, the closed perimeter followed by the lateral wall has a section very slightly larger than the section of the drainage duct.

According to another feature, the liquid store comprises a bottom joined to the lateral wall about the entire closed perimeter.

According to another feature, the bottom is positioned in a first plane substantially parallel to a second plane containing the downstream end of the drainage duct when the hatch is in the closed position.

According to another feature, the bottom is positioned so as to be pressed against the downstream end of the drainage duct or spaced apart by a distance less than 1 cm from this downstream end when the hatch is in the closed position.

According to another feature, the drainage device comprises a ring joint interposed between the drainage duct and the liquid store when the hatch is in the closed position.

The invention also relates to an aircraft comprising a drainage device according to one of the preceding features.

### BRIEF DESCRIPTION OF THE DRAWINGS

Further features and advantages will become apparent from the following description of the invention, which description is given solely by way of example, with reference to the appended drawings in which:

FIG. 1 is a perspective view of a rear portion of an aircraft with a detail view of a zone of the fuselage of the aircraft comprising a drainage device, illustrating one embodiment of the invention,

FIG. 2 is a longitudinal schematic cross section of a drainage device, illustrating a first embodiment of the invention,

FIG. 3 is a perspective view of a hatch of the drainage device shown in FIG. 2,

FIG. 4 is a longitudinal schematic cross section of a drainage device, illustrating a second embodiment of the invention,

FIG. 5 is a perspective view of a hatch of the drainage device shown in FIG. 4, and

FIG. 6 is a longitudinal perspective cross section of a portion of an aircraft fitted with a drainage device illustrating the second embodiment of the invention.

### DETAILED DESCRIPTION OF THE PREFERRED EMBODIMENTS

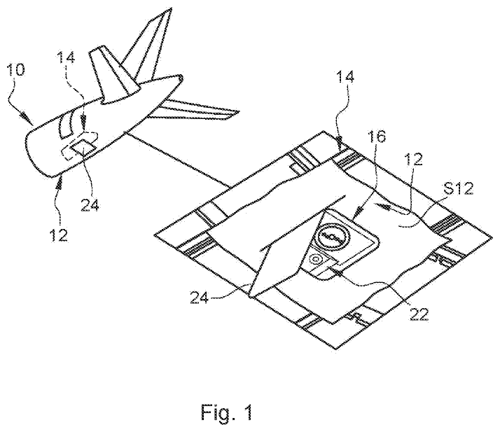

According to an embodiment shown in FIGS. 1 to 6, an aircraft 10 comprises a fuselage 12, at least one tank 14 designed to store waste water and a drainage device 16 designed to make the tank 14 communicate with an outer zone of the fuselage 12. This drainage device 16 comprises a drainage duct 18 that has an upstream end opening into the tank 14 and a downstream end 18.1 accessible from the outside the fuselage 12, to which a discharge duct may be connected and a drainage valve 20 positioned between the upstream and downstream ends of the drainage duct 18. This drainage valve 20 is designed to occupy an open state in which the drainage valve 20 allows a flow in the drainage duct 18 from the upstream end towards the downstream end, and a closed state in which the drainage valve 20 prevents any flow in the drainage duct 18.

According to one embodiment, the drainage valve 20 has a ball plug and a control 20.1 that can be actuated by an operator to switch the drainage valve from the closed state to the open state or vice versa.

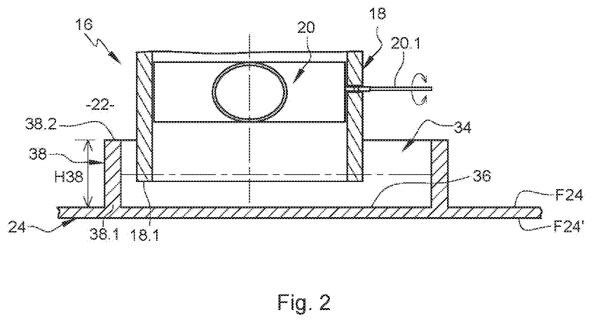

The drainage device 16 also comprises at least one housing 22, which is recessed with respect to the outer surface S12 of the fuselage 12, and a hatch 24 moveable between an open position (shown in FIG. 1) in which the hatch 24 opens the housing 22 and a closed position (shown in FIGS. 2, 4 and 6) in which the hatch 24 closes the housing 22.

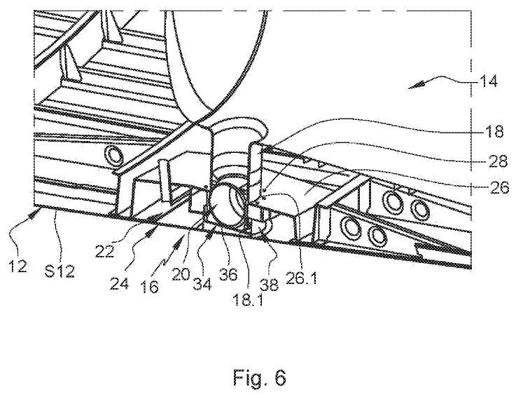

As illustrated in FIG. 6, the housing 22 is delimited by a wall 26 that comprises a hole 26.1 to enable the drainage duct 18 to pass through the wall 26. Additionally, the drainage device 16 comprises a link 28 rigidly joining the wall 26 and the drainage duct 18. According to one arrangement, the drainage duct 18 comprises a collar pressed against the wall 26 and joined to said wall by joining elements (bolts or rivets, for example) distributed about the circumference of the drainage duct 18.

The hatch 24 comprises an inner face F24 oriented toward the drainage duct 18 when the hatch 24 is in the closed position and an outer face F24′ opposite the inner face F24 and positioned to extend the outer surface S12 of the fuselage 12 when the hatch 24 is in the closed position.

The aircraft comprises at least one articulation 30 for joining the hatch 24 to the fuselage 12 and/or to the wall 26 of the housing 22, as well as a locking/unlocking system 32 for holding the hatch 24 in the closed position.

The housing 22 is dimensioned to house at least the downstream end 18.1 of the drainage duct 18 and the control 20.1 of the drainage valve 20. Thus, when the hatch 24 is in the closed position, the downstream end 18.1 of the drainage duct 18 is spaced apart from the inner face F24 of the hatch 24 by a distance of between 0.5 cm and 10 cm. All of these elements are not described further since they may be identical to those of the prior art. Unlike in the prior art, it is possible for the drainage device 16 to not have a cap.

According to one particular feature of the invention, the hatch 24 comprises a liquid store 34 positioned on the inner face F24 thereof, into which the drainage duct 18 opens when the hatch 24 is in the closed position, designed to collect and store any liquid coming out of the drainage duct 18 in the event of a leak. This liquid store 34 provided on the inner face F24 of the hatch 24 obviates the need to provide a cap. Consequently, the hatch 24 does not need to be modified to house said cap.

This liquid store 34 comprises at least one lateral wall 38 that extends along a closed perimeter. This lateral wall 38 extends between a lower edge 38.1 joined to the inner face F24 of the hatch 24 and an upper edge 38.2 remote from the inner face F24 of the hatch 24. This wall 38 is substantially vertical when the hatch 24 is in the closed position. By substantially, it is meant within +/−10%.

According to one configuration, the lateral wall has a height H38 (distance between the lower and upper edges 38.1, 38.2), such that the downstream end 18.1 of the drainage duct 18 is positioned between the inner face F24 of the hatch 24 and a surface containing the upper edge 38.2. When the hatch 24 is in the closed position, the height H38 of the lateral wall 38 of the liquid store 34 is equal to or greater than the distance separating the downstream end 18.1 of the drainage duct 18 and the inner face F24 of the hatch 24.

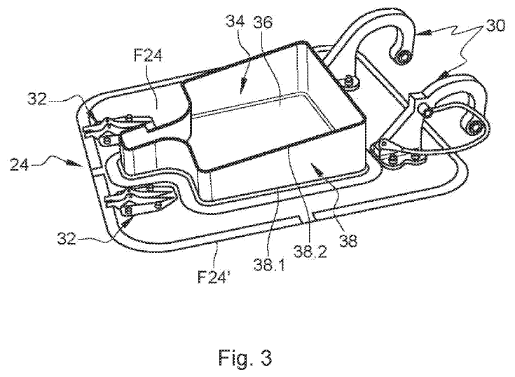

As illustrated in FIG. 3, the lateral wall 38 does not necessarily have a constant height about the entire closed perimeter. According to one embodiment, the height H38 of the lateral wall 38 is determined so that the upper edge 38.2 is positioned in a substantially horizontal plane when the hatch 24 is in the closed position.

According to one embodiment, the liquid store 34 comprises a bottom 36 joined to the lateral wall 38 about the entire closed perimeter.

According to a configuration shown in FIGS. 2 and 3, the bottom 36 of the liquid store 34 is the inner face F24 of the hatch 24.

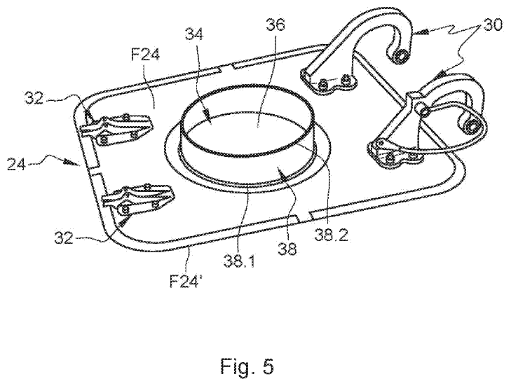

According to another configuration, shown in FIGS. 5 and 6, the bottom 36 is an element separate from the hatch 24. According to this configuration, the bottom 36 is positioned in a first plane substantially parallel to a second plane containing the downstream end 18.1 of the drainage duct 18 when the hatch 24 is in the closed position. The bottom 36 is positioned so as to be pressed against the downstream end 18.1 of the drainage duct 18 or slightly spaced apart (by a distance less than 1 cm) from this downstream end 18.1 when the hatch 24 is in the closed position.

According to a first embodiment shown in FIGS. 2 and 3, the lateral wall 38 follows a closed perimeter, removed and separate from the drainage duct 18. According to this first embodiment, the closed perimeter followed by the lateral wall 38 is determined so that the volume of the liquid store 34 is as large as possible. This enables the visits required to empty the liquid store 34 to be spaced apart in time.

According to this first embodiment, the liquid store 34 is not closed by the drainage duct 18, even when the hatch 24 is in the closed position.

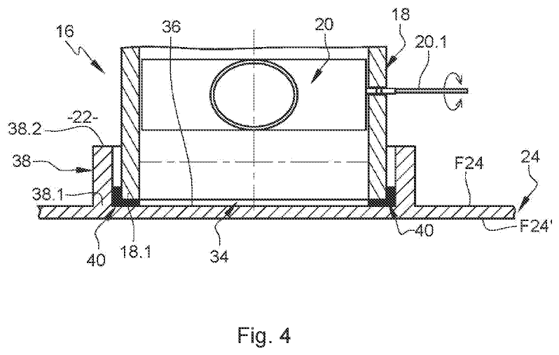

According to a second embodiment shown in FIGS. 4 to 6, the lateral wall 38 follows a closed perimeter that has a section very slightly larger than the section of the drainage duct 18. Thus, when the hatch 24 is in the closed position, the lateral wall 38 is slightly spaced apart from the drainage duct 18 about the entire circumference thereof. Slightly spaced apart means that the distance separating the lateral wall 38 and the drainage duct 18 is less than 1 cm about the entire circumference.

According to one configuration, the drainage duct 18 has a circular section. Additionally, the lateral wall 38 follows a circular closed perimeter that is coaxial with the drainage duct 18 when the hatch 24 is in the closed position and has a diameter slightly larger than the external diameter of the drainage duct 18.

According to the second embodiment, the drainage device 16 comprises a ring joint 40 interposed between the drainage duct 18 and the liquid store 34 when the hatch 24 is in the closed position, more specifically between the downstream end 18.1 of the drainage duct 18 and the bottom 36 and/or the lateral wall 38 of the liquid store 34.

According to one configuration, the ring joint 40 is a natural or synthetic rubber joint. This ring joint 40 may be rigidly connected to the liquid store 34 when the hatch 24 is in the open position.

According to the second embodiment, the liquid store 34 is closed when the hatch 24 is in the closed position, unlike in the first embodiment. According to this embodiment, the bottom 36 and the lateral wall 38 of the liquid store 34 form a cap rigidly connected to the hatch 24.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An aircraft comprising:
a fuselage,
at least one tank for storing waste water, and
a drainage device for the tank comprising
a drainage duct that has an upstream end configured to open into the tank and a downstream end to which a discharge duct is configured to be connected,
a drainage valve positioned between the upstream and downstream ends of the drainage duct,
a housing dimensioned to house at least the downstream end of the drainage duct, and
a hatch configured to move between an open position in which the hatch opens the housing and a closed position in which the hatch closes the housing, the hatch comprising an inner face oriented toward the drainage duct when the hatch is in the closed position and an outer face opposite the inner face and positioned to extend the fuselage when the hatch is in the closed position,
wherein the hatch comprises a liquid store positioned on the inner face thereof, into which the drainage duct opens when the hatch is in the closed position, the liquid store configured to collect and store any liquid coming out of the drainage duct.

2. The aircraft as claimed in claim 1, wherein the liquid store comprises at least one lateral wall that extends along a closed perimeter between a lower edge joined to the inner face of the hatch and an upper edge remote from the inner face of the hatch.

3. The aircraft as claimed in claim 2, wherein the lateral wall has a height, corresponding to a distance between the lower and upper edges thereof, such that the downstream end of the drainage duct is positioned between the inner face of the hatch and a surface containing the upper edge of the lateral wall.

4. The aircraft as claimed in claim 2, wherein the upper edge of the lateral wall is positioned in a substantially horizontal plane when the hatch is in the closed position.

5. The aircraft as claimed in claim 2, wherein the closed perimeter followed by the lateral wall is remote and separate from the drainage duct.

6. The aircraft as claimed in claim 2, wherein the closed perimeter followed by the lateral wall has a section very slightly larger than the section of the drainage duct.

7. The aircraft as claimed in claim 2, wherein the liquid store comprises a bottom joined to the lateral wall about the entire closed perimeter.

8. The aircraft as claimed in claim 7, wherein the bottom is positioned in a first plane substantially parallel to a second plane containing the downstream end of the drainage duct when the hatch is in the closed position.

9. The aircraft as claimed in claim 8, wherein the bottom is positioned so as to be pressed against the downstream end of the drainage duct or spaced apart by a distance less than 1 cm from this downstream end when the hatch is in the closed position.

10. The aircraft as claimed in claim 1, wherein the drainage device further comprises a ring joint interposed between the drainage duct and the liquid store when the hatch is in the closed position.
